(19) United States
(12) Patent Application Publication
(10) Pub. No.: US 2021/0402420 A1
(43) Pub. Date: Dec. 30, 2021

(54) Nozzle with lateral spray

(71) Applicant: Mytee Products, Inc., Poway, CA (US)

(72) Inventors: John LaBarbera, Poway, CA (US); Vincent LaBarbera, Poway, CA (US)

(21) Appl. No.: 16/946,538

(22) Filed: Jun. 25, 2020

(51) Int. Cl. B05B 1/04; B05B 1/26; A47L 11/34

(52) U.S. Cl. CPC B05B 1/046; A47L 11/34; B05B 1/267

(57) ABSTRACT

A nozzle with lateral spray includes a longitudinal bore with an open first end at a proximal end of the body of the nozzle and a dead second end in a distal portion of the body of the nozzle; a recess defined within a lateral wall of the body of the nozzle, which has a bottom and side walls extending perpendicularly to the longitudinal axis of the body; and a lateral bore that fluidly connects the longitudinal bore to an opening in the recess and has a diameter smaller than the diameter of the longitudinal bore. A nozzle according to the invention provides a lateral spray that is stronger and better focused than nozzles according to the prior art.

### FIELD OF THE INVENTION

The present invention concerns a nozzle providing a lateral spray. More particularly, the present invention concerns a nozzle providing a lateral spray against underlying surfaces that is more powerful than nozzles known in the art.

### BACKGROUND OF THE INVENTION

Surface cleaning machines, such as floor cleaning machines, generally include a bar supporting nozzles that spray a cleaning solution against a surface to be cleaned. The sprayed cleaning solution, together with any removed dirt particles, is then removed by vacuum generated by the cleaning machine.

FIG. 1 depicts an example of a floor cleaning machine 2 according to the prior art, which includes a nozzle bar 4 that supports a plurality of nozzles 6 that deliver a cleaning solution 8 against a surface to be cleaned.

Nozzles for surface cleaning machines known in the art are configured to deliver the cleaning solution either though an opening provided at a longitudinal end of the nozzle, therefore, in a longitudinal direction, or through an opening provided in a side of the nozzle, therefore, in a lateral direction.

Nozzles with longitudinal delivery are disclosed, for example, in U.S. Pat. Nos. 2,641,509 and 3,747,155. Those nozzles generate a spray in a longitudinal direction, which impinges on and can loosens dirt particles attached to a surface to be cleaned, for example, to strands of a floor carpet, by impact. This type of nozzle, however, is poorly suited for a surface cleaning machine such as that illustrated in FIG. 1, where nozzles 6 are arranged parallel to the surface to be cleaned. With that arrangement, nozzles with a longitudinal delivery would provide a liquid spray that is parallel to the surface to be cleaned, so that the cleaning solution would necessarily impinge horizontally against a facing surface, and then percolate downward onto the surface to be cleaned. That arrangement would deliver the cleaning solution to the surface to be cleaned with low strength and would have a poor capability to remove dirt particles by physical impact.

Nozzles with lateral delivery are disclosed, for example, in U.S. Pat. Nos. 3,326,473 and 3,935,896. Those documents describe either a multi-part nozzle where the traveling fluid is first slowed into an internal chamber and then deviated toward a lateral conduit, from which it is ejected as a conical spray; or a nozzle where the fluid travels horizontally and is the ejected from the nozzle through a slit in a lateral wall of the nozzle.

Another nozzle with lateral delivery is disclosed in U.S. Pat. No. 5,813,087, which describes a type of nozzle that is commonly used in current floor cleaning machines. In that type of nozzle, a cleaning solution travels longitudinally along the nozzle and is ejected longitudinally through an opening that faces an angularly disposed wall, against which the cleaning solution impinges. After impact, the cleaning solution is deflected toward the underlying surface to be cleaned. The deflected fluid, however, becomes atomized and loses a significant portion of its strength. Consequently, the cleaning solution loses the ability to dislodge dirt particles from the surface to be cleaned, in particular, the deflected cleaning solution loses the ability to break the surface tension of a dirt film formed on carpet strands.

### SUMMARY OF THE INVENTION

In one aspect, the present invention relates to a nozzle with lateral spray that has a longitudinal bore with an open first end at a proximal end of the nozzle body and a dead second end positioned in a distal portion of the nozzle body; a recess defined within a lateral wall of the nozzle body, with a bottom and side walls extending perpendicularly to the longitudinal axis of the body; and a lateral bore that fluidly connects the longitudinal bore to an opening in the recess and has a diameter smaller than the diameter of the longitudinal bore. A nozzle according to the invention provides a lateral spray that is stronger and better focused than nozzles according to the prior art.

The opening in the recess is positioned at an apical end of a triangular slit within the bottom of the recess, defined between the side walls of the recess. The bottom of the recess may be convex and have a plurality of faces, and the triangular slit may be defined in a central position within the bottom of the recess.

In one embodiment, the longitudinal bore has proximal section of larger diameter and a distal section of smaller diameter, which are connected by a frusto-conical section so as to create a Venturi effect on the traveling fluid.

A side bore, coaxial with the lateral bore, may extend from the distal section of the longitudinal bore to an aperture in a lateral wall of the body that is opposite to the recess. Therefore, a fluid or a tool entering the side bore may be able to travel along a straight line to the lateral bore and to the opening in the recess. The side bore may be threaded, so as to connect to a conduit feeding a fluid into the nozzle, or receive a tool, or, when not in use, engage a plug closing the side bore.

In one embodiment, the body of the nozzle has a distal portion with a plurality of lateral walls, and a proximal portion that is adapted to engage an opening in a nozzle bar. For example, the proximal portion may be configured to provide a threaded, flanged, quick-connect, or bayonet connection of the nozzle to the nozzle bar. In one embodiment, the plurality of lateral walls extends along the entire distal portion of the nozzle body, from the proximal portion of the nozzle body till the distal end.

A notch may be defined in the distal portion of the nozzle body and extend from a longitudinal mid-point of the distal portion till the distal end of the nozzle body. Such notch facilitates access to a tool engaging the nozzle. In that configuration, the recess is housed within at least a portion of the notch.

### BRIEF DESCRIPTION OF THE DRAWINGS

The drawings constitute a part of this specification and include exemplary embodiments of the invention, which may be embodied in various forms. It is to be understood that in some instances various aspects of the invention may be shown exaggerated or enlarged to facilitate an understanding of the invention.

FIG. 1 illustrates a nozzle bar in a floor cleaning machine according to the prior art.

FIG. 2 illustrates a front perspective view of a nozzle with lateral spray according to the invention.

FIG. 3 illustrates a front elevational view of the nozzle of FIG. 2.

FIG. 4 illustrates a cross-sectional view of the nozzle of FIG. 2.

FIG. 5 illustrates a left side view of the nozzle of FIG. 2.

FIG. 6 illustrates a right side view of the nozzle of FIG. 2.

FIG. 7 illustrates a rear elevational view of the nozzle of FIG. 2.

FIG. 8 illustrates a rear perspective view of the nozzle of FIG. 2.

FIG. 9 illustrates a top plan view of the nozzle of FIG. 2.

FIG. 10 illustrates a bottom plan view of the nozzle of FIG. 2.

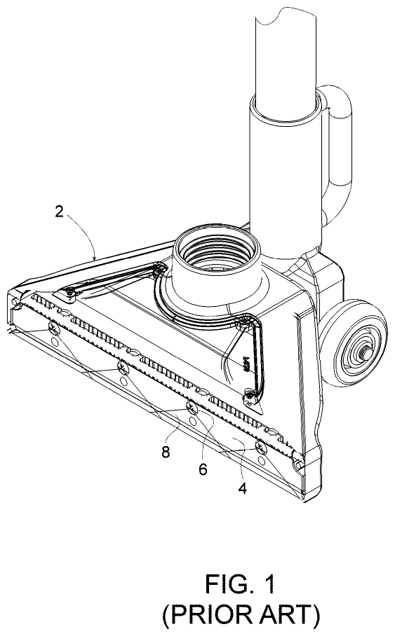

### DETAILED DESCRIPTION OF EMBODIMENTS OF THE INVENTION

Detailed descriptions of embodiments of the invention are provided herein. It is to be understood, however, that the present invention may be embodied in various forms. Therefore, the specific details disclosed herein are not to be interpreted as limiting, but rather as a representative basis for teaching one skilled in the art how to employ the present invention in virtually any detailed system, structure, or manner.

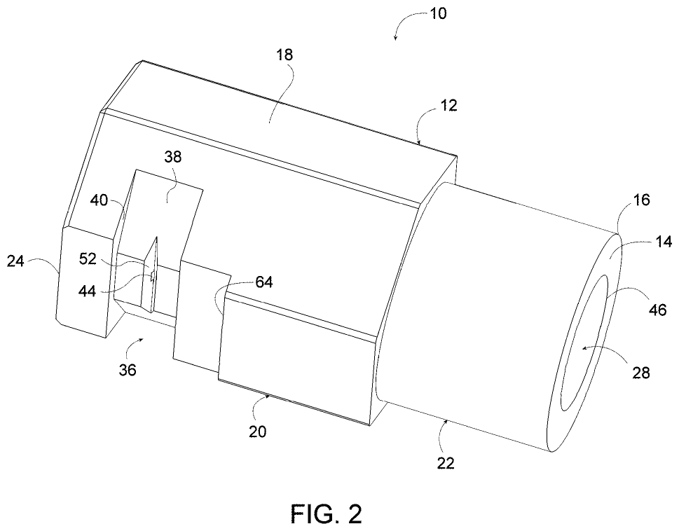

FIG. 2 illustrates a nozzle with a lateral spray according to the invention. Nozzle 10 includes a body 12 that is defined by a base 14 at a proximal end 16, a proximal portion 22 extending longitudinally from base 14 and having a cylindrical configuration, and a distal portion 20 extending from proximal portion 22 and having a hexagonal cross-section defined by six lateral walls 18, as shown in FIG. 9. In other embodiments, distal portion may have a cylindrical cross-section defined by a single lateral wall, or may have other cross-sectional shapes, such as square or octagonal.

In the illustrated embodiment, lateral walls 18 extend for the entirety of distal portion 20, beginning at an end of proximal portion 22 and ending at distal end 24. Having a nozzle 10 with a plurality of lateral walls in its distal portion, such as lateral walls 18 in distal portion 20 in the illustrated embodiment, facilitates the use of a wrench when nozzle 10 is engaged into a nozzle bar or other support member.

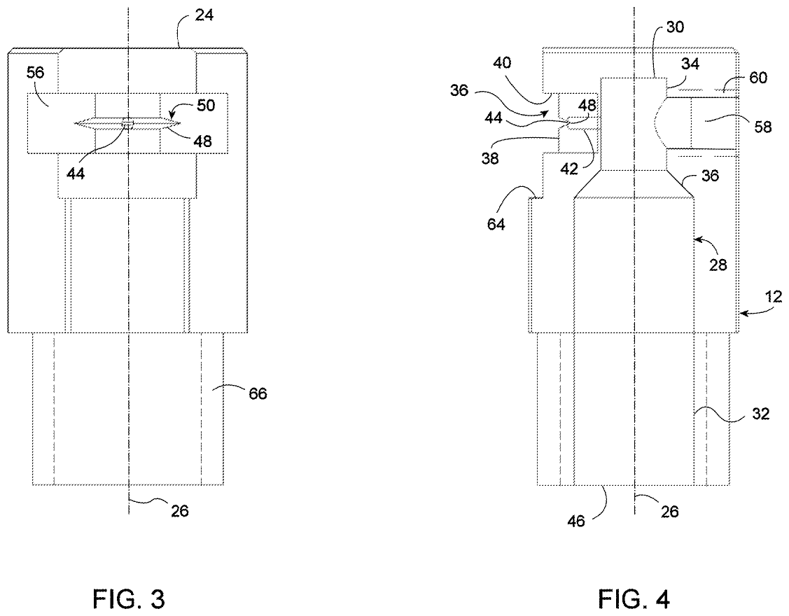

Proximal portion 22 is configured to be inserted in a nozzle bar or other support member. To that end, proximal portion 22 may be threaded and have threads, as shown in FIG. 3. In other embodiments, proximal portion 22 may be configured to provide a flanged, quick-connect, or bayonet connection. In still other embodiments, proximal portion 22 may not be cylindrical but may instead be defined by a plurality of lateral wall in polyhedron configuration.

With reference now to FIGS. 3 and 4, body 12 defines a longitudinal axis 26. A longitudinal bore 28 extends along body 12 parallel to longitudinal axis 26 and has an open first end 46 situated in base 14, and a dead second end 30 situated in distal portion 20 of body 12. “Parallel” is defined herein to include both coaxial or offset positions.

In the illustrated embodiment, longitudinal bore 28 has a proximal section 32, beginning at open first end 46, and a distal section 34, ending at dead second section 30. Proximal section 32 has a larger diameter than distal section 34, and proximal section 32 is fluidly connected to distal section 34 by frusto-conical section 36, which creates a Venturi effect between distal section 34 and proximal section 32 and increases the velocity of a fluid 54 traveling from first open end 46 toward dead second end 30.

A recess 36 is carved on a side of distal portion 20 within lateral walls 18. Recess 36 is defined by a bottom 38 and side walls 40, which extend perpendicularly to longitudinal axis 26. In the illustrated embodiment, bottom 38 is convex and defined by a plurality of faces 56, so as to have a pattern similar to that of lateral walls 18. In other embodiments, however, bottom 38 may have a different configuration, for example, bottom 38 may have a convex arcuate shape.

A lateral bore 42 fluidly connects distal section 34 of longitudinal bore 28 to recess 36, beginning at or near dead second end 30 and ending at an opening 44 situated in recess 36. Lateral bore 42 has a diameter smaller that the diameter of distal portion 20, which causes an additional increase in the velocity of fluid 54 traveling from first open end 46 of longitudinal bore 28 toward opening 44.

Opening 44 is defined within a triangular slit 50 defined centrally within bottom 38 of recess 36, perpendicularly to longitudinal axis 26 and between side walls 40. Triangular slit 50 has an apical end 48, which extends inwardly into body 12, and a base end 52 defined in bottom 38 of recess 36 between side walls 40. Opening 44 is positioned at apical end 48, so at to cause fluid 54 exiting opening 44 to be projected into triangular slit 50 and between side walls 40.

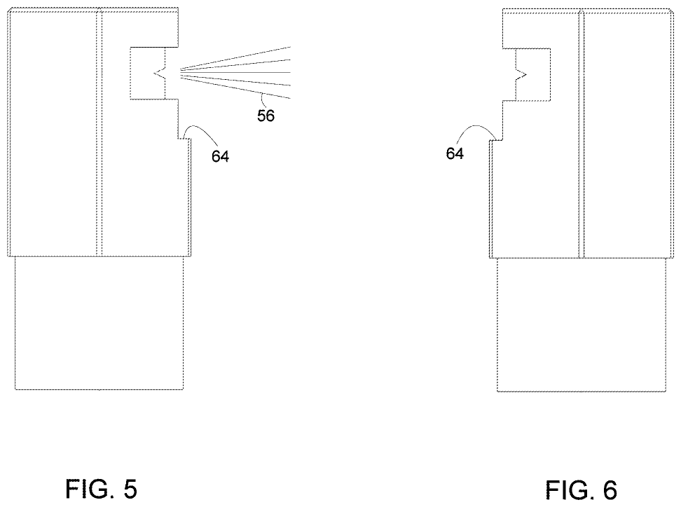

In one embodiment, opening 44 is tubular and has a circular shape at its inward end facing the interior of nozzle 10, and an essentially rectangular shape at its outward end, facing the outside environment. This design of opening 44 can be seen in FIG. 3. Overall, the configuration of nozzle 10 causes fluid 54, after being injected into longitudinal bore 28 at open first end 46, to accelerate through frusto-conical section 36, travel along distal section 34 at a higher speed, and further accelerate along lateral bore 42 until exiting body 12 at opening 44. As shown in FIG. 5, the speed acquired by fluid 54, as well as the configuration and position of triangular slit 50 and side walls 40, causes fluid 54 to be projected from nozzle 10 onto an underlaying surface as a forceful spray, which increases the cleaning power of fluid 54 due to the impacting strength on the underlaying surface.

The shapes and positions of opening 44, triangular slit 50 and side walls 40 insure that fluid 54 is ejected as a spray having a triangular blade shape with essentially flat tops and bottoms, so as to maximize its impact strength against dirt particles attached to a surface to be cleaned and break the surface tension of a dirt film formed on carpet strands.

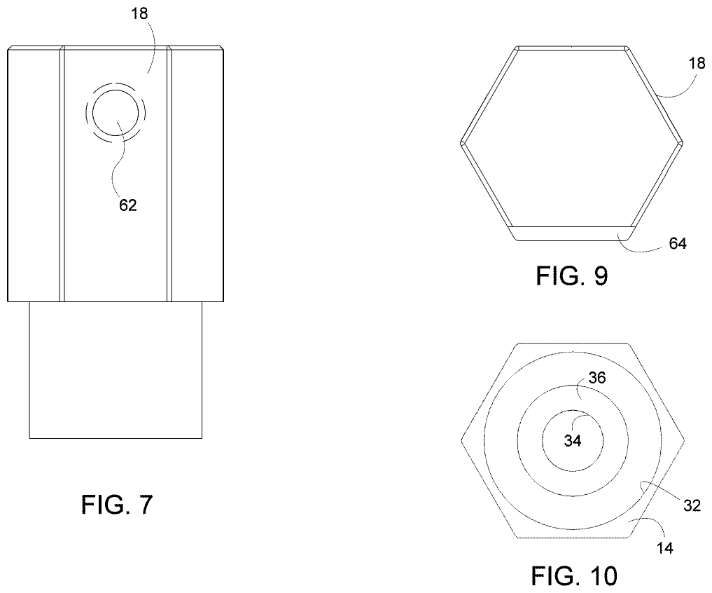

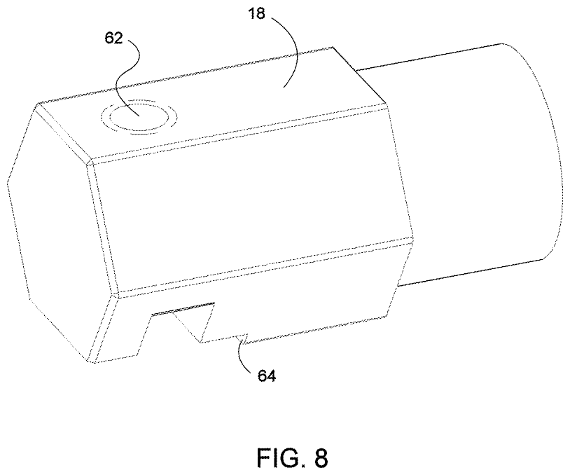

With reference now to FIGS. 4, 7, and 8, body 12 may further include a side bore 58, which is coaxial with lateral bore 42, and which fluidly connects the outer environment with distal section 34 of longitudinal bore 28. Therefore, fluid 54 or a tool entering the side bore may be able to travel along a straight line to lateral bore 42 and opening 44. Side bore 58 may be internally threaded with threads 60, or have other engaging means such as a flanged, quick-connect or bayonet connection to receive and engage a device attached thereto.

For example, side bore 58 may be engaged to a conduit so as to provide a second fluid inlet for a fluid to be also sprayed through opening 44, which becomes carried toward opening 44 by the flow of fluid 56. In another application, side bore 58 may be engaged to a tool that either drills out lateral bore 42 during the manufacture of nozzle 10, or that unplugs or anyway operates on lateral bore 42 for maintenance purposes.

When not in use, side bore 58 may be plugged with a plug 62, which has a side wall correspondingly threaded to threads 60, so as to firmly close side bore 58 and prevent loss of fluid and pressure. Preferably, plug 62 is so configured that its outer end is flush with the corresponding lateral wall 18.

In one embodiment, body 12 includes a notch on distal portion 20 of body 12. In the illustrated embodiment, notch 12 is configured as an inward lowering of one of lateral walls 18, parallel to longitudinal axis 26 and extending from a middle portion of body 12 to distal end 24 of the body 12. One of the advantages of notch 12 is to provide an easier access to a tool engaging nozzle 10, when nozzle 10 is affixed to a nozzle bar or other surface and access space to nozzle 10 is tight.

While the invention has been described in connection with the above described embodiments, it is not intended to limit the scope of the invention to the particular forms set forth, but on the contrary, it is intended to cover such alternatives, modifications, and equivalents as may be included within the scope of the invention. Further, the scope of the present invention fully encompasses other embodiments that may become obvious to those skilled in the art and the scope of the present invention is limited only by the appended claims.

The invention claimed is:

1. A nozzle comprising:
a body defining a longitudinal axis, the body having a base at a proximal end and one or more lateral walls;
a longitudinal bore defined within the body, the longitudinal bore having an open first end at the base of the body and a dead second end;
a recess defined within the one or more lateral walls, the recess having a bottom and side walls extending perpendicularly to the longitudinal axis of the body; and
a lateral bore defined within the body, the lateral bore fluidly connecting the longitudinal bore to an opening in the recess, the lateral bore having a diameter smaller than a diameter of the longitudinal bore,
wherein the opening is positioned at an apical end of a triangular slit within the bottom of the recess, the triangular slit being perpendicular to the longitudinal axis of the body, the triangular slit further having a base end disposed between the side walls of the recess.

2. The nozzle of claim 1, wherein the longitudinal bore has a proximal section extending from the open first end and a distal section joined to the lateral bore, the proximal section having a larger diameter than the distal section, a frusto-conical section connecting the proximal section to the distal section.

3. The nozzle of claim 2, further comprising a side bore coaxial with the lateral bore, the side bore extending from the distal section of the longitudinal bore to an aperture in one of the one or more lateral walls of the body opposite to the recess.

4. The nozzle of claim 3, wherein the side bore is threaded.

5. The nozzle of claim 3, wherein the side bore is configured to receive a plug closing the side bore.

6. The nozzle of claim 1, wherein the opening is tubular and has a circular shape at an inward end facing an interior of the body and an essentially rectangular shape at an outward end facing an outside environment.

7. The nozzle of claim 1, wherein the bottom of the recess is convex and has a plurality of faces, the triangular slit being defined in a central position within the bottom.

8. The nozzle of claim 1, wherein the body has a plurality of lateral walls, and further has a proximal portion adapted to engage an opening in a nozzle bar.

9. The nozzle of claim 8, wherein the plurality of lateral walls extends from the proximal portion to a distal end of the body.

10. The nozzle of claim 8, wherein the proximal portion is configured to provide a threaded, flanged, quick-connect, or bayonet connection.

11. The nozzle of claim 1, further comprising a notch defined in the one or more lateral walls of the body, the notch extending from a middle portion of the body to a distal end of the body, the recess being housed within at least a portion of the notch.
